(19) United States
(12) Patent Application Publication
(10) Pub. No.: US 2007/0046926 A1
(43) Pub. Date: Mar. 1, 2007

(54) Fingerprint identification assembly using reflection to identify pattern of a fingerprint

(76) Inventors: Jung-Chun Wu, Taichung (TW); Jyh-Long Chern, Taichung (TW); Ching-Shan Dai, Taichung (TW); Yung-Wen Lin, Taichung (TW); Jyh-Der Hwang, Taichung (TW)

Correspondence Address: HERSHKOVITZ & ASSOCIATES, 2845 DUKE STREET, ALEXANDRIA, VA, 22314, US

(21) Appl. No.: 11/211,709

(22) Filed: Aug. 26, 2005

(51) Int. Cl. G06K 9/74

(52) U.S. Cl. 356/71

(57) ABSTRACT

A fingerprint identification assembly includes a laminated lens having a first lens, a second lens and a third lens formed together with the first lens and the second lens, each of the first lens, the second lens and the third lens has a dielectric film coated thereon. At least one illuminator is located at a bottom of the laminated lens and a sensor located under the laminated lens for picking up an image of a fingerprint on top of the laminated lens. The dielectric film of the laminated lens allows light from the at least one illuminator to be partially reflected due to the fingerprint on the laminated lens and partially penetrates through the second lens and the third lens to be picked up by the sensor.

### BACKGROUND OF THE INVENTION

1. Field of the Invention

The present invention relates to a fingerprint identification assembly, and more particularly to a fingerprint identification assembly having a first lens, a second lens and a third lens formed together with the first lens and the second lens such that a mix of reflection and penetration of the light in correspondence to a pattern of the fingerprint on top of the first lens of the assembly is able to focus an image of the fingerprint to be sensed by a sensor of the assembly.

2. Description of Related Art

Fingerprint identification is probably one of the oldest and best established methods to identify a person. It is of the field of biometrics, i.e. identifying people by measuring or sensing parts of a human body, which is of importance for a variety of applications. Many automated techniques are currently in use or under development, including palm print reading, finger pore reading, hand geometry identifying and iris, retina or face recognition. Among which, fingerprint identification is rather straightforward and it now promises to find wider acceptance as it is convenient and a secure alternative to typed password, keys or signature for access to limited area or information.

Basically the identification task involves determination of the identity of an unknown person based on a fragment of a fingerprint pattern, or verification of the identity of a known person to a level of certainty based on the pattern of the specific fingerprint. Exact identification of fingerprint characteristics is desired for universal need, i.e., different machines can recognize the characteristics. On the other hand, in many situations, the identifications are not necessarily universal, but require clear resolution only. Human fingertips have distinctive patterns of curved ridges, with a period of about 0.5˜1.0 mm depth of about 0.1 mm. Finger tissue scatters red light with a diffuse reflectivity of about 50%, and the refractive index of a finger is about 1.51. It may be desirable to have as large a field of view as possible with minimum distortion to provide more features for identification and more margin of error in finger placement for the need of universal identification. On the other hand, with a touch platform on which fingerprint will be identified, the effective size of fingerprint could be about 10 mm, but the size of system size has to be rather small, less than 10 mm for cellular phone application for example. Many kinds of fingerprint reorganization devices have been developed. They are mainly first to record the ridge patterns, and software extracts the coordinates and classes of features like ridge ends and bifurcations (called “minutiae”). With software, distortion can be corrected, but image blur is difficult to remove. There is also a line of tiny pores on the ridges that is more difficult to resolve, but can be used to provide more information for identification. U.S. Pat. Appln. No. 2002/003892 from M. Iwanaga proposed a novel method of fingerprint imaging in air for a cellular phone. However, for a finger in air, ridges may be seen by the specular reflection of light from a localized source, but image contrast is limited by the underlying scattering, and tipping of the finger so it is not perfectly flat on the imaging surface. The rounded shape of the finger can cause unacceptable distortion of the image. In contrast, when using the contact methods, the user flattens the fingertip against a surface (touch platform); then ridges and valleys can be distinguished by height differences between the ridges and the valleys. Identification using the contact method has been widely used. There are electronic sensors that measure capacitance variation, and optical sensors that view the finger pressed against a transparent platen or window. Optical contact sensors record changes of specular reflectance, imaged onto a sensor such as a CCD or CMOS detector array. The pixel size of optical contact sensor can be down to −5 μm and the sensor can be quite small with a suitable quantity of pixels for sufficient resolution capability.

Most fingerprint identification devices are bright-field devices. That is, they produce a dark fingerprint ridge pattern on a light background. To produce a fingerprint image with acceptable contrast, additional optical components are required to generate a uniformly bright background. Because of the additional components, it is difficult to make a compact bright-field device. Betensky of U.S. Pat. No. 5,900,993, issued on May 4, 1999 and entitled “Lens System for Use in Fingerprint Detection” describes a lens system in which a first and second lens in combination with a third cylindrical lens are employed to reduce optical distortion. However, an approach using cylindrical lenses requires additional components and inherently complicates the alignment of the lens system because a lack of symmetry causes failure in the alignment process in handling an extra degree of freedom in lens placement. In viewing the needs of compact fingerprint identification in small volumes, such as that for a keyboard, Clark et. al. further demonstrate a compact design with a focal lens system and dark-field illumination in U.S. Pat. No. 6,643,390, issued in November 2003.

What is needed in emergent consumer application is a compact fingerprint identification device having suitable image quality with minimum distortion which can be adapted for use in a small compartment, such as a cellular phone or an ultra-thin electronic device or personal belongings, and which contains a minimum number of components so as to facilitate production.

The major difficulty for a compact fingerprint-imaging device is the system volume has to be quite small, while the object size and sensor size are not small at all; in other words, the effective field of view become large in both image space and object space. To smooth the difficulty in designing the lens, one possible way is to utilize the partial reflective system such that the effective total length can be increased. This kind of system has been invented, in a name of concentric optical system, by Togino et al in 1997. (U.S. Pat. No. 5,644,436) for usable as either an imaging optical system or an ocular optical system. Togino et al demonstrated that the concentric optical system enables a clear image even at a field angle of up to about 90.degree. and with a pupil diameter of up to about 10 millimeters with substantially no chromatic aberration. However, fingerprinting imaging device strictly requires a finite-conjugate system configuration, unlike those claimed by Togino et al in which object is away from the lens or located at an infinite position away from the lens.

To overcome the shortcomings, the present invention tends to provide an improved compact fingerprint identification assembly to mitigate the aforementioned problems.

### SUMMARY OF THE INVENTION

The primary objective of the present invention is to provide a fingerprint identification assembly using a mix of reflection and penetration of light in correspondence to a fingerprint to identify pattern of the fingerprint.

In one aspect of the present invention, the fingerprint identification assembly has a first lens, a second lens and a third lens formed together with the first lens and the second lens. Further, at least one light source located under the laminated lens to project light to the laminated lens and a sensor is provided under the laminated lens to pick up reflected image of the fingerprint.

Other objects, advantages and novel features of the invention will become more apparent from the following detailed description when taken in conjunction with the accompanying drawings.

### BRIEF DESCRIPTION OF THE DRAWINGS

FIG. 1 is a schematic side plan view showing that a finger is placed on top of the laminated lens of the assembly of the present invention;

FIG. 2 is a schematic view showing light path from the light source to focus image of the fingerprint so as to be picked up by the sensor;

FIG. 3 is a schematic view showing a different application of the laminated lens;

FIG. 4 is a schematic view showing still a different application of the laminated lens;

FIG. 5 is a side view of a lens head in accordance with the present invention;

FIG. 6 is a diagram of a typical aberration behavior of the lens head in FIG. 5;

FIGS. 7A and 7B are diagrams of a typical MTF performance of the lens head in FIG. 5;

FIG. 8A is a distortion plot of the lens head in FIG. 5;

FIG. 8B is a spot diagram of the lens head in FIG. 5;

FIG. 9 is a side view of a lens head of a preferred embodiment and the lens prescription is illustrated in table 2;

FIG. 10 is a diagram of a typical aberration behavior of the lens head in FIG. 9;

FIGS. 11A and 11B are diagrams of a typical MTF performance of the lens head in FIG. 9;

FIG. 12A is a distortion plot of the lens head in FIG. 9;

FIG. 12B is a spot diagram of the lens head in FIG. 9;

FIG. 13 is a side view of a lens head of a preferred embodiment and the lens prescription is illustrated in table 3; FIG. 14 is a diagram of a typical aberration behavior of the lens head in FIG. 13;

FIGS. 15A and 15B are diagrams of a typical MTF performance of the lens head in FIG. 13;

FIG. 16A is a distortion plot of the lens head in FIG. 13; and

FIG. 16B is a spot diagram of the lens head in FIG. 13.

### DETAILED DESCRIPTION OF THE PREFERRED EMBODIMENT

Examples 1 to 3 of the concentric optical system according to the present invention will be described below with reference to the Figures. For demonstration, the object height is 6 mm, and hence the object size is 12 mm. The F-number is 3.5. The wavelength of illumination light source is 720 nm.

### Example 1

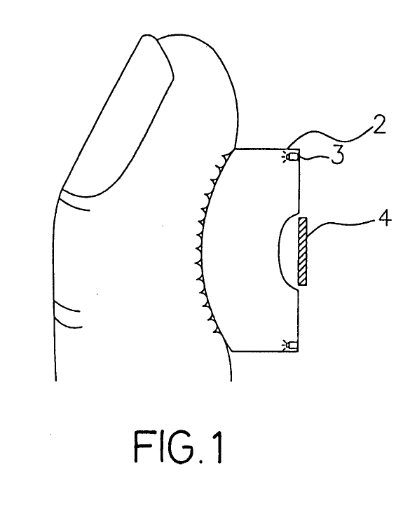

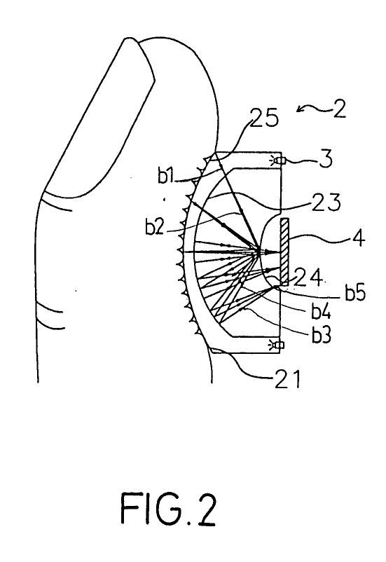

Example 1 of the present invention will be explained below with reference to FIG. 1. The lens head is formed by two different materials, here the first one is a plastic materials (acryl) and the second is of glass (BK7). The lens prescription is shown in table 1. In the current embodiment, the surfaces are all spherical. FIGS. 2, 3, and 4 graphically show aberration, MTF, distortion and spot diagram respectively, in this example.

TABLE 1

| surface | radius | thickness | materials |
|---|---|---|---|
| Obj | 7.880369 | 5.00000 | Acryl |
| 1 | 2.110090 | −5.00000 | Reflect |
| 2 | 7.880369 | 5.00000 | Reflect |
| 3 | 2.110090 | 6.263463 | BK7 |
| ims | 0 | 0 | |

### Example 2

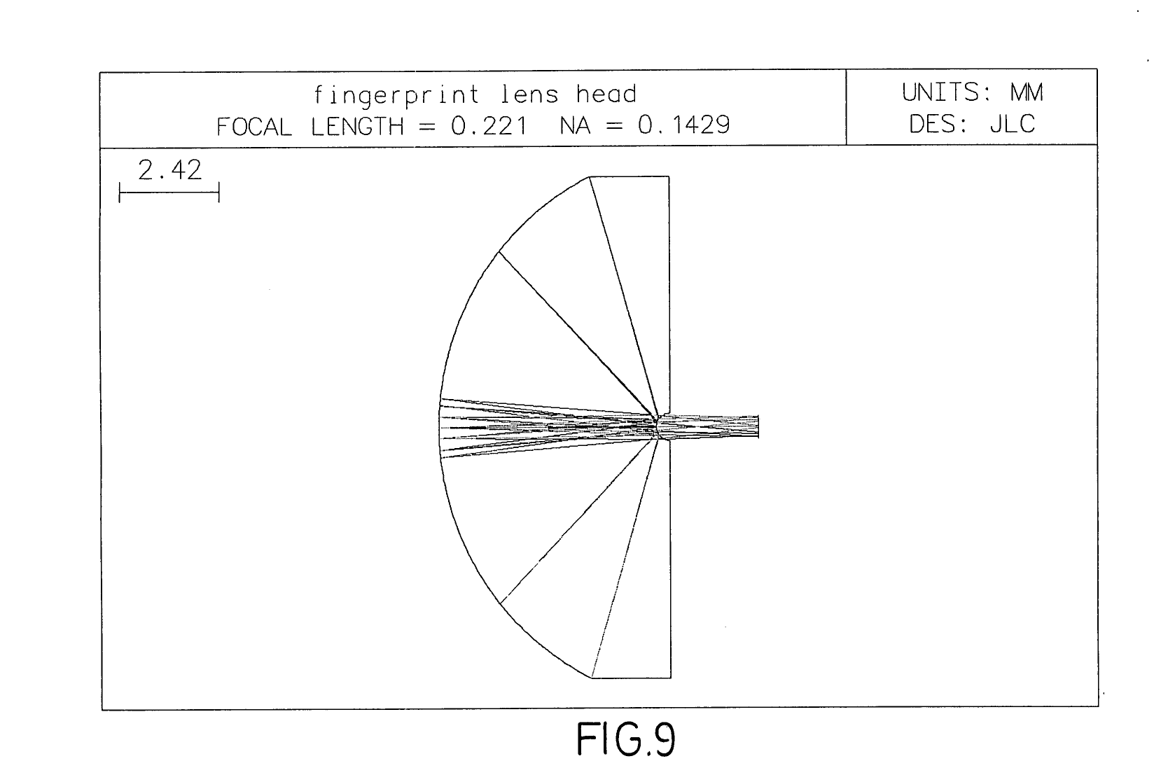

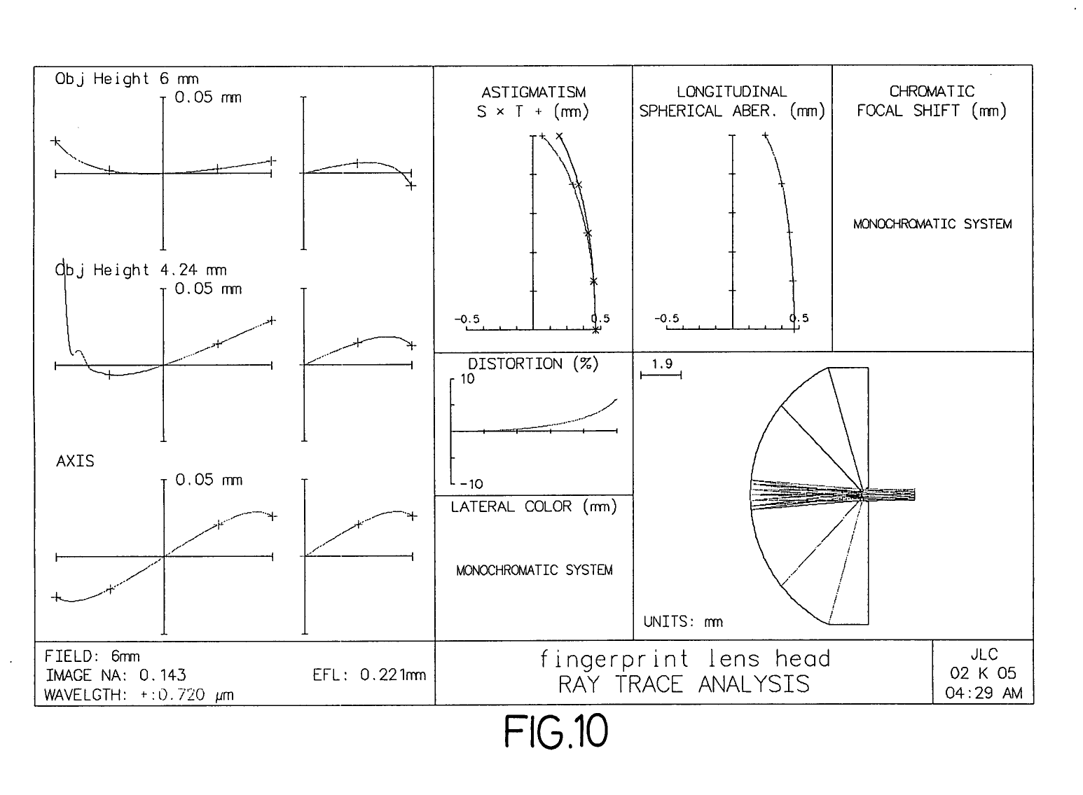

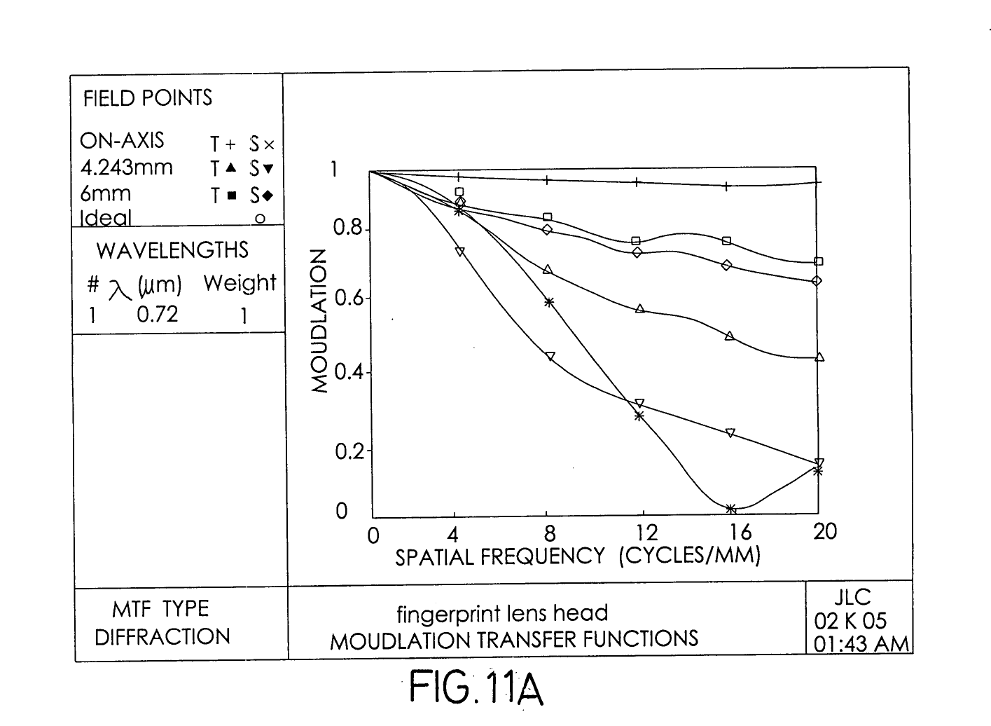

Example 2 of the present invention will be explained below with reference to FIG. 9. The lens head is formed by two different materials, here the first one is a plastic materials (acryl) and the second is of glass (BK7). The lens prescription is shown in table 2. The total thickness of current embodiment has been reduced within 10 mm. In the current embodiment, the surfaces are all spherical. FIGS. 10, 11A, 11B, 12A and 12B graphically show aberration, MTF, distortion and spot diagram respectively, in this example.

TABLE 2

| surface | radius | thickness | materials |
|---|---|---|---|
| Obj | 6.730158 | 5.3 | Acryl |
| 1 | 0.322989 | −5.3 | Reflect |
| 2 | 6.730158 | 5.3 | Reflect |
| 3 | 0.322989 | 2.5 | BK7 |
| ims | 0 | 0 | |

### Example 3

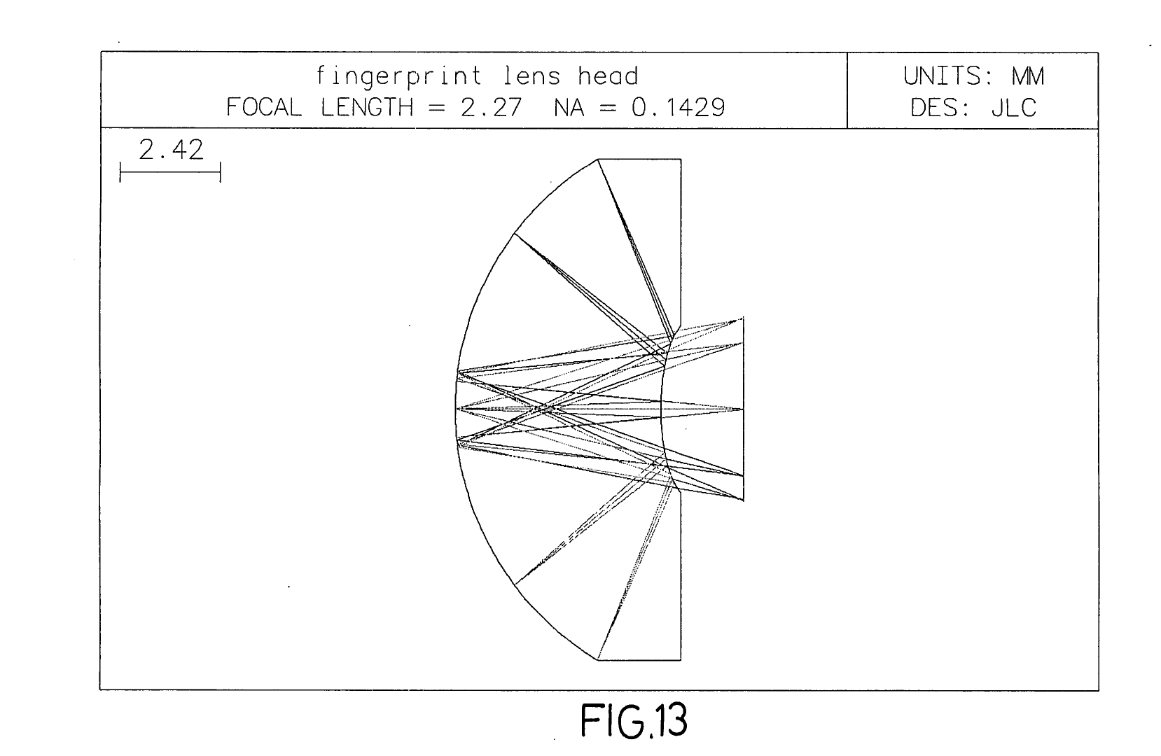

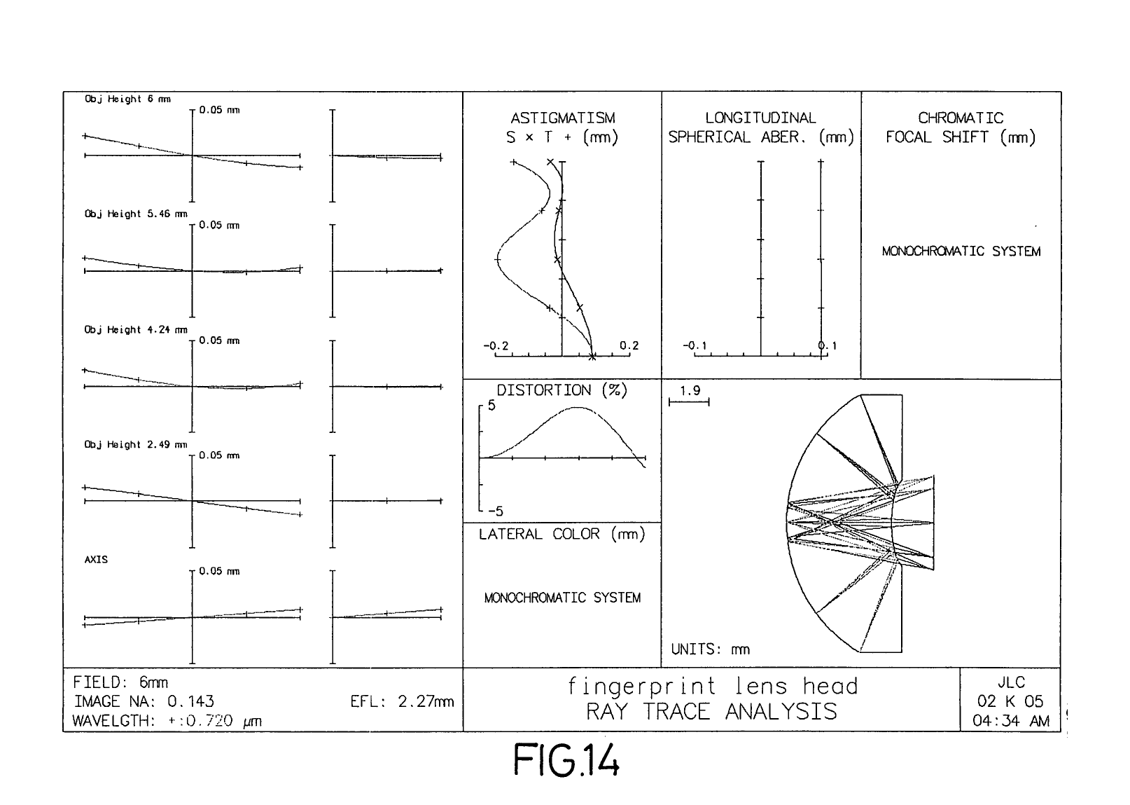

Example 3 of the present invention will be explained below with reference to FIG. 13. The lens head is formed by two different materials, here the first one is a plastic materials (acryl) and the second is of glass (BK7). The lens prescription is shown in table 3. The total thickness of current embodiment has been reduced within 10 mm. In the current embodiment, the second surface is an aspherical surface. For aspheric surface, the sag equation is described by

$$z = \frac{{cy}^{2}}{1 + \sqrt{1 - ( 1 + κ ) {c}^{2} {y}^{2}}} + {ADy}^{4} + {AEy}^{6} + {AFy}^{8} + {AGy}^{10}$$

where c is the surface curvature (c=1/r, r is the radius of curvature), y is the radial distance from the axis, and k is the conic constant, AD, AE, AF, and AG are the fourth, sixth, eighth, and tenth order deformation coefficients. FIGS. 14, 15A, 15B, 16A, 16B graphically show aberration, MTF, distortion and spot diagram respectively, in this example. In this embodiment, the aspheric coefficients of surface 1 and 3 follow

AD=−0.004813, AE=0.003481, AF=−9.6981X10-5. The conic constant CC and the aspherical coefficient AG are 0.

TABLE 3

| surface | radius | thickness | materials |
|---|---|---|---|
| Obj | 6.928947 | 5.0 | Acryl |
| 1 | 5.606262 | −5.0 | Reflect |
| 2 | 6.928947 | 5.0 | Reflect |
| 3 | 5.606262 | 2.0 | BK7 |
| ims | 0 | 0 | |

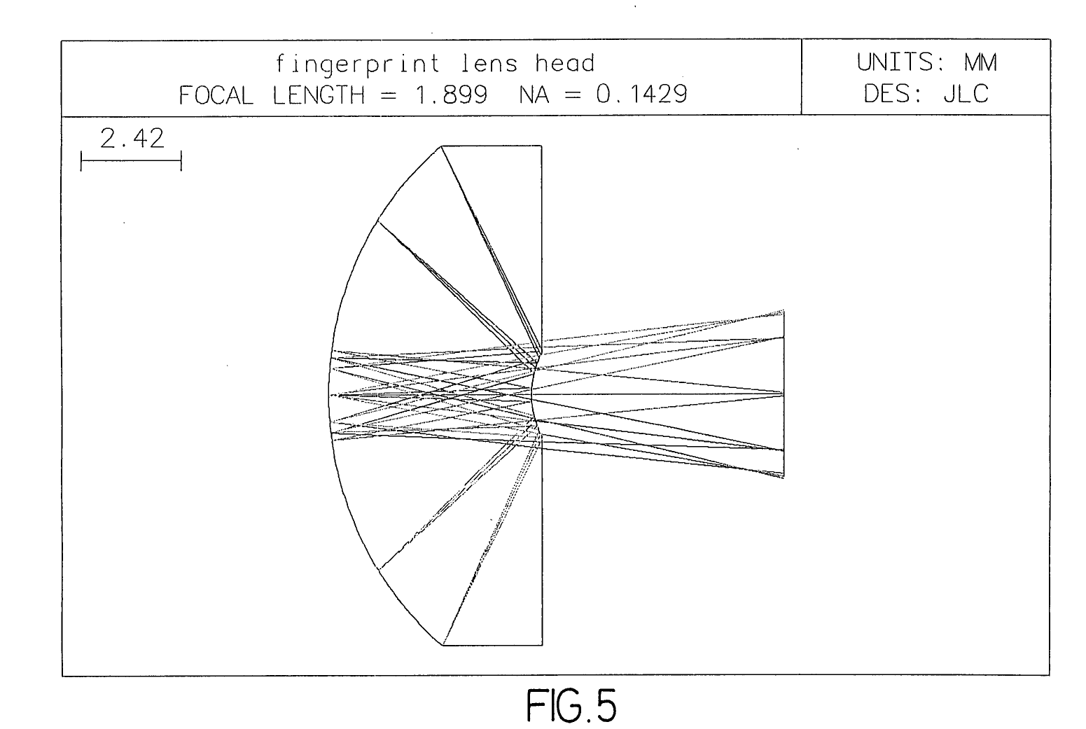

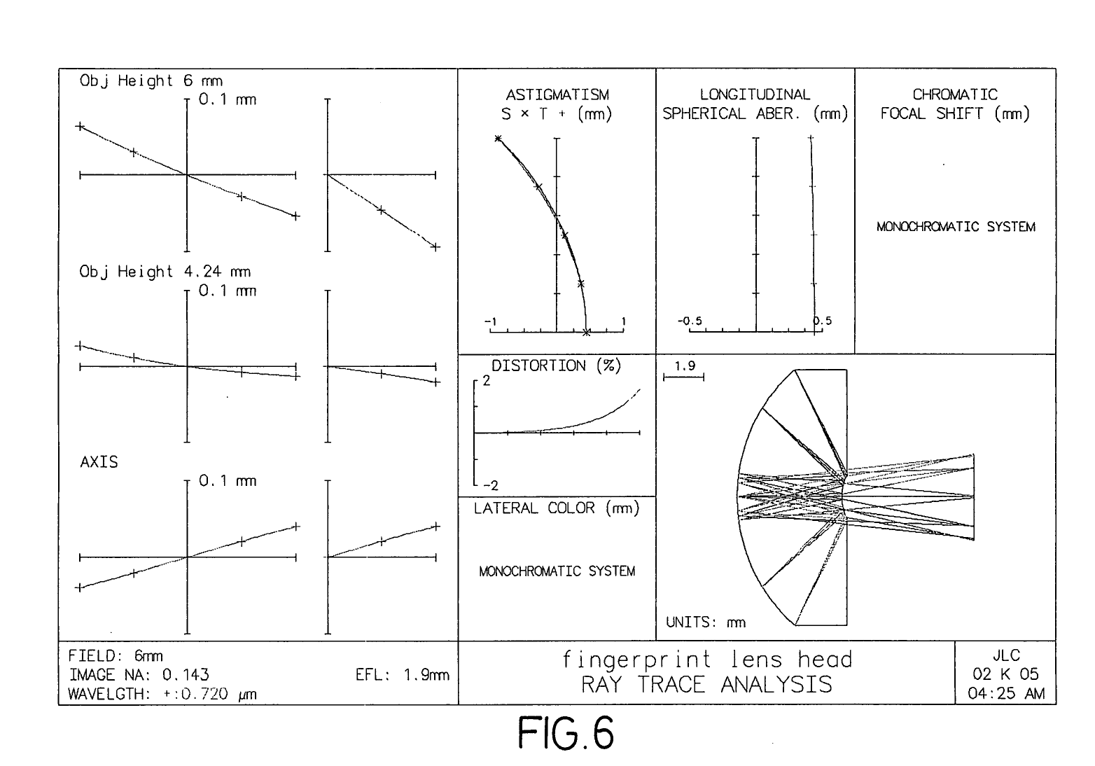

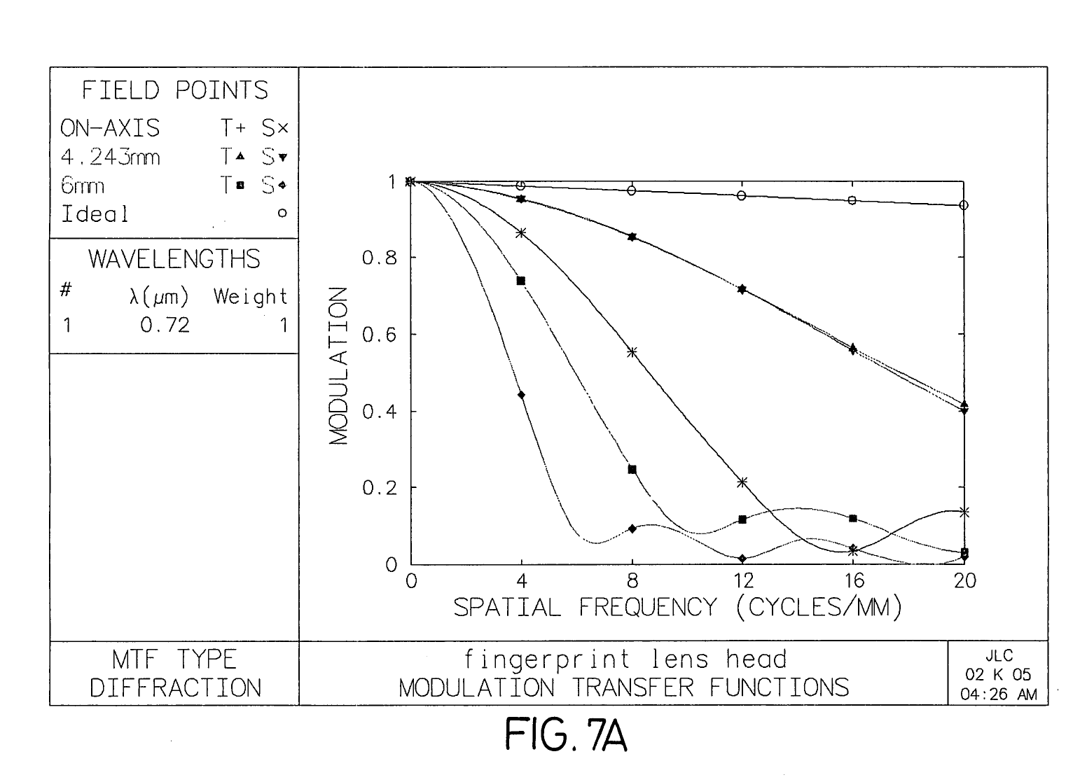

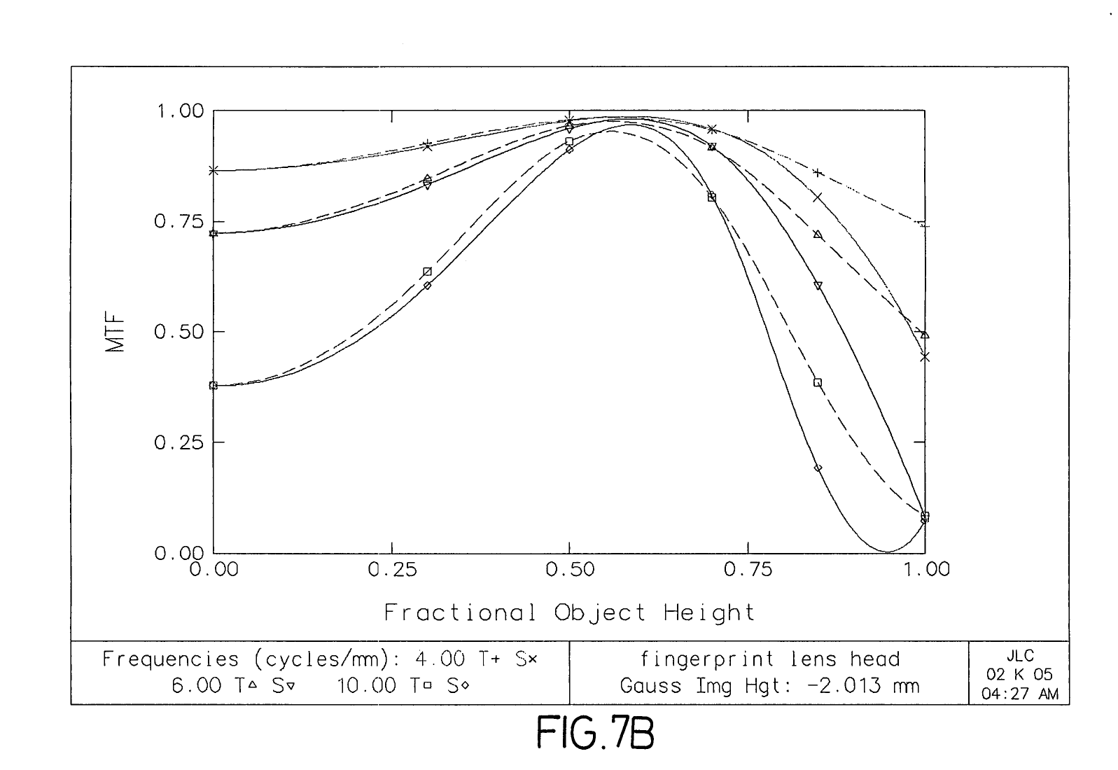

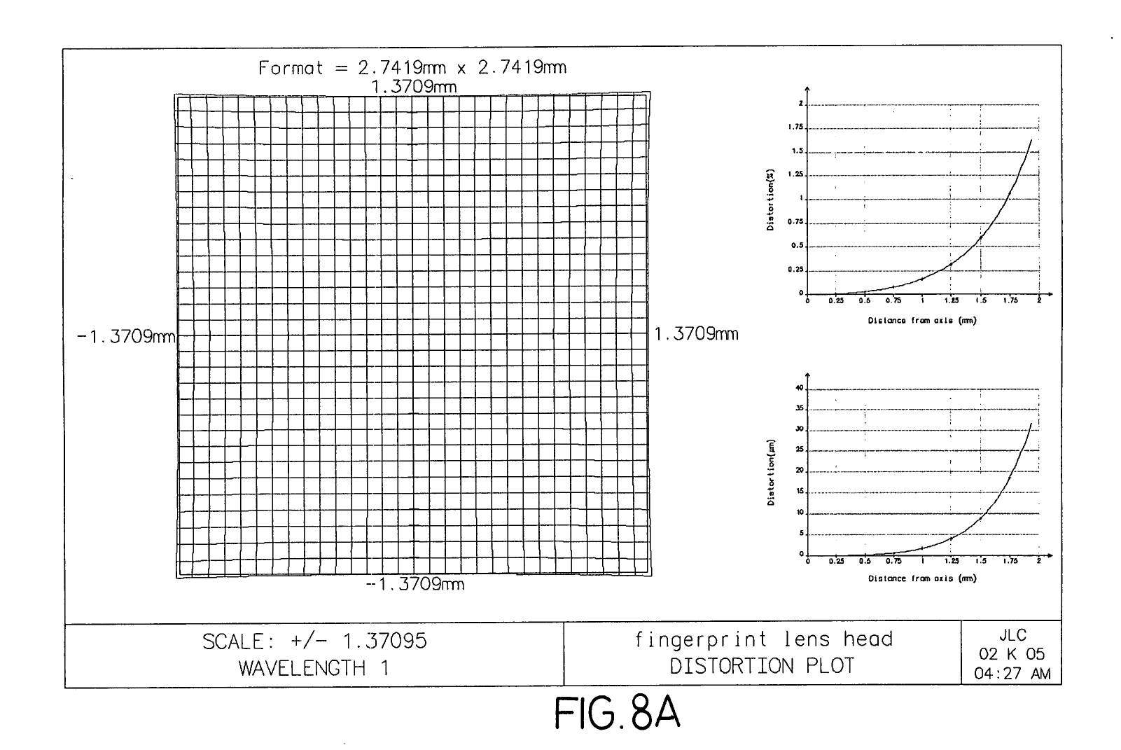

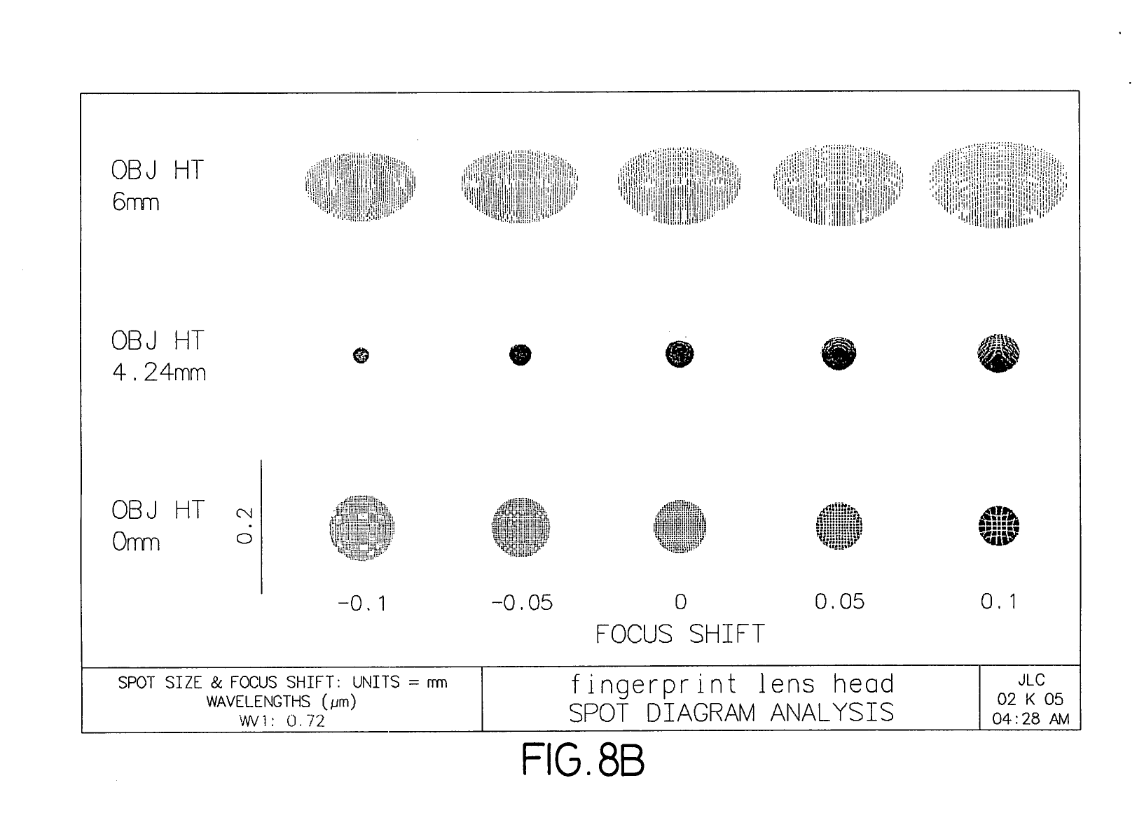

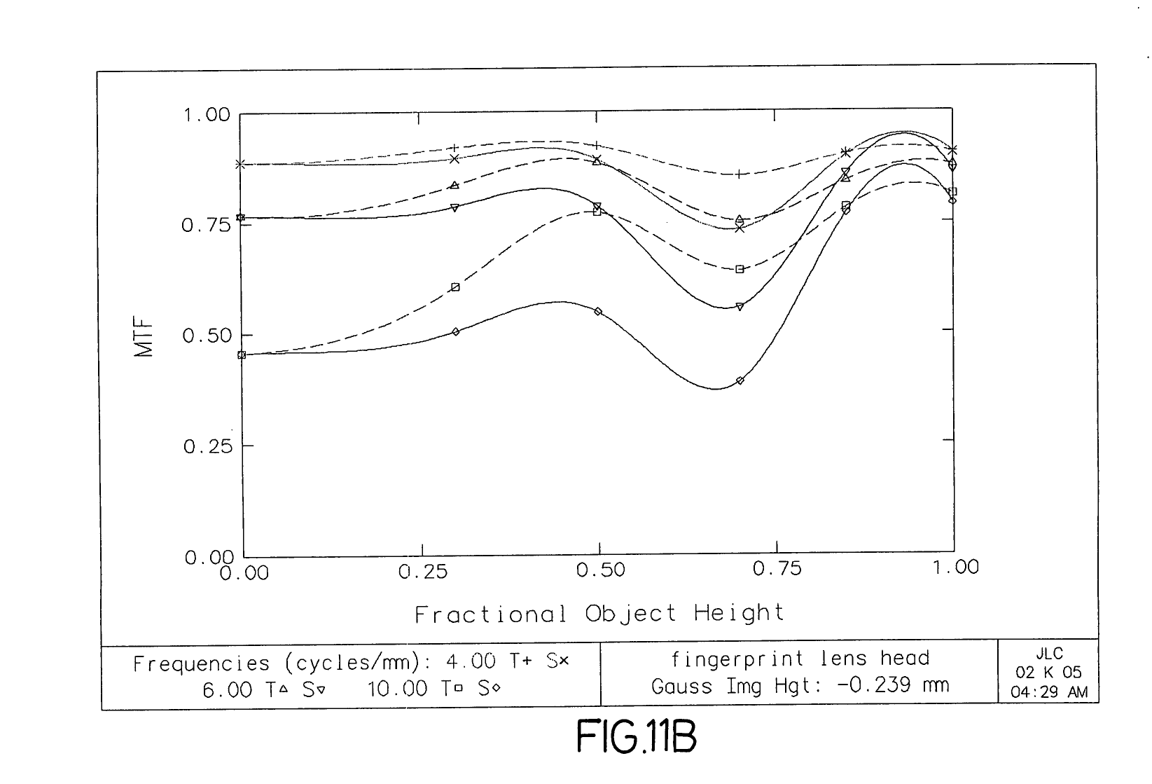

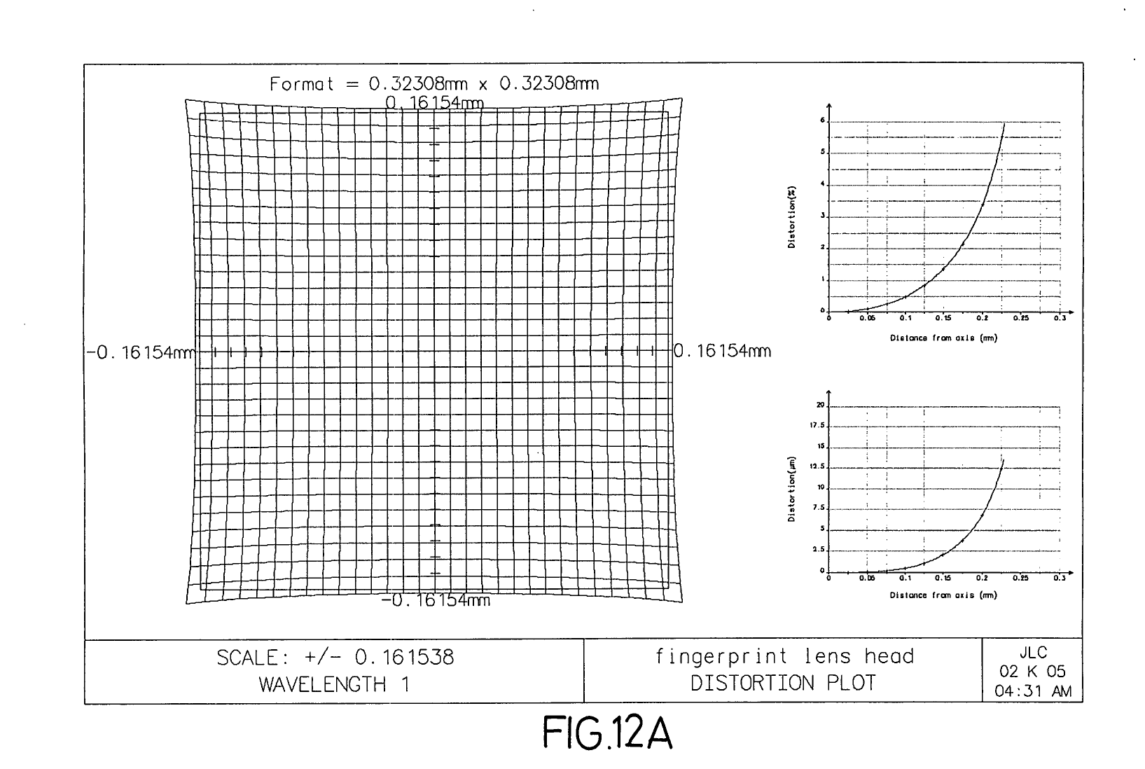

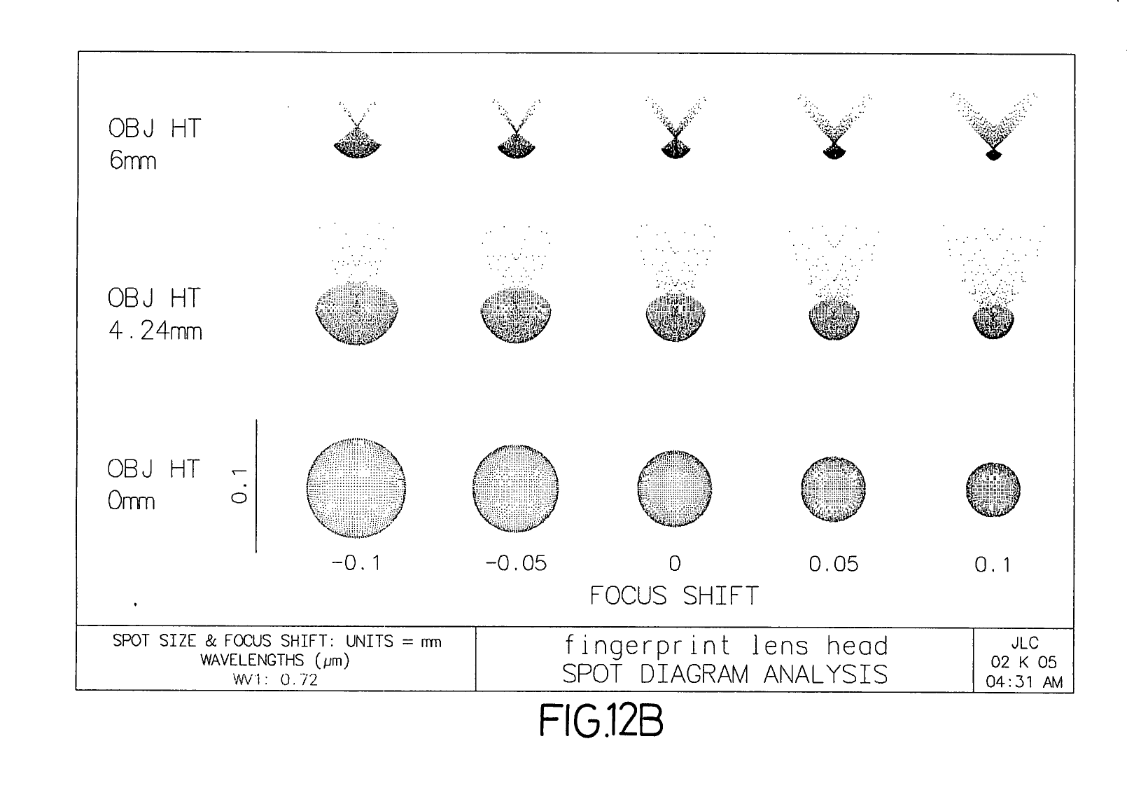

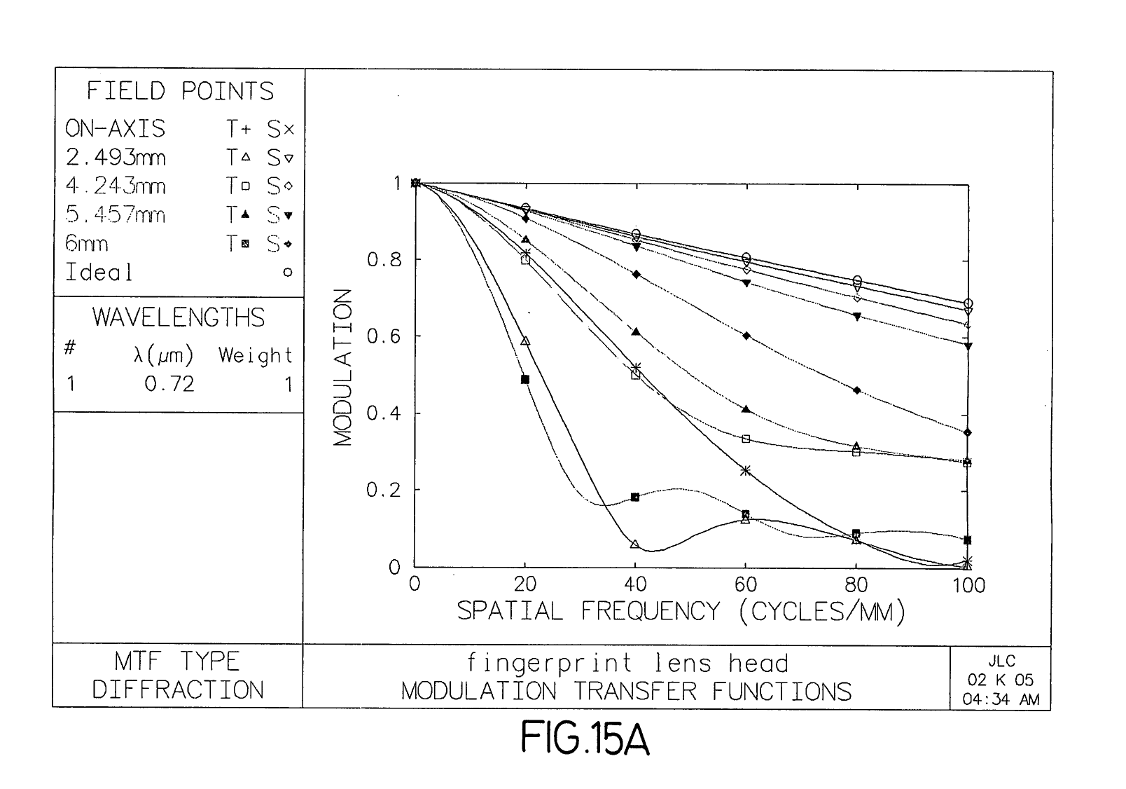

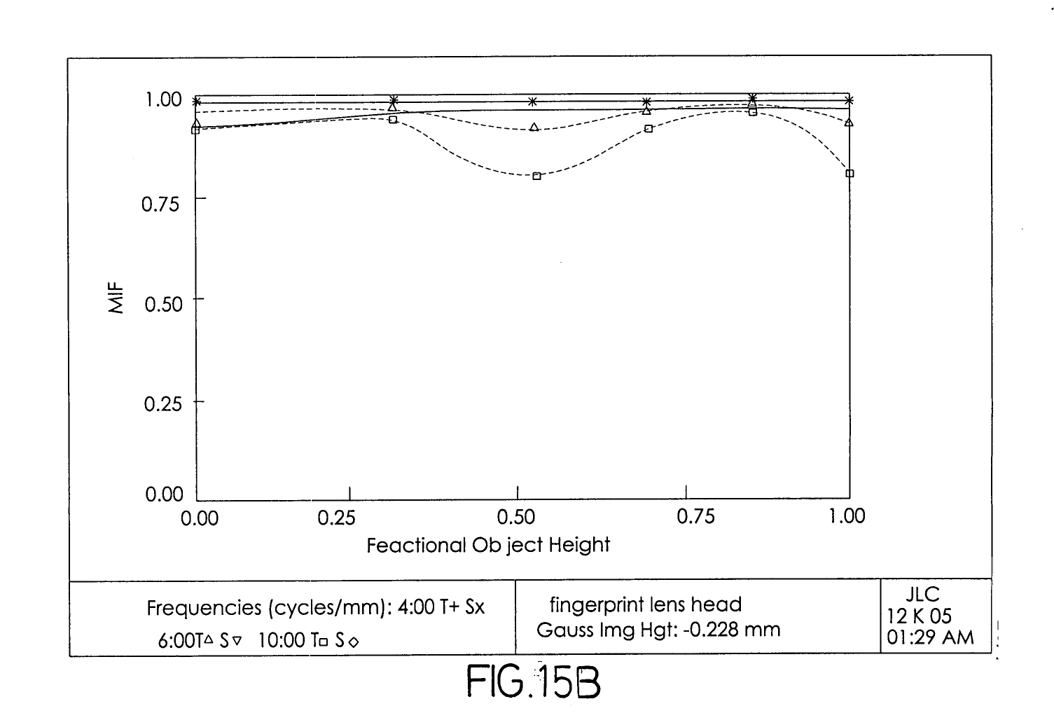

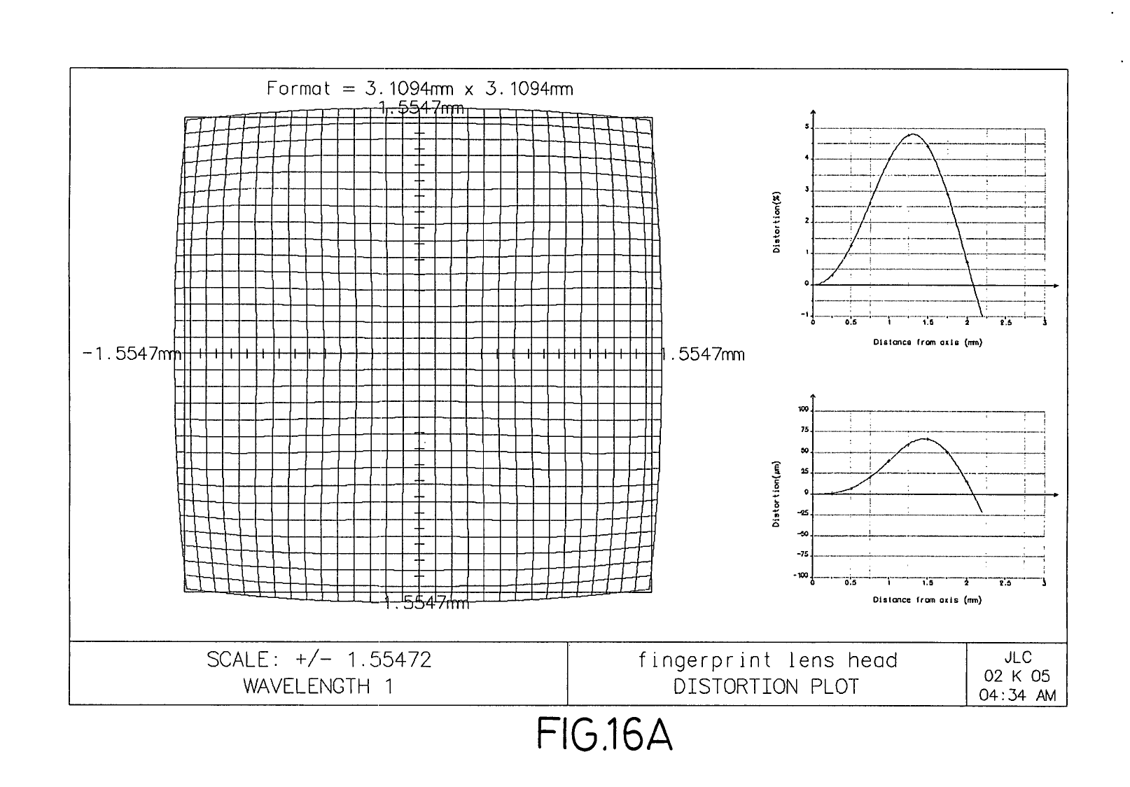

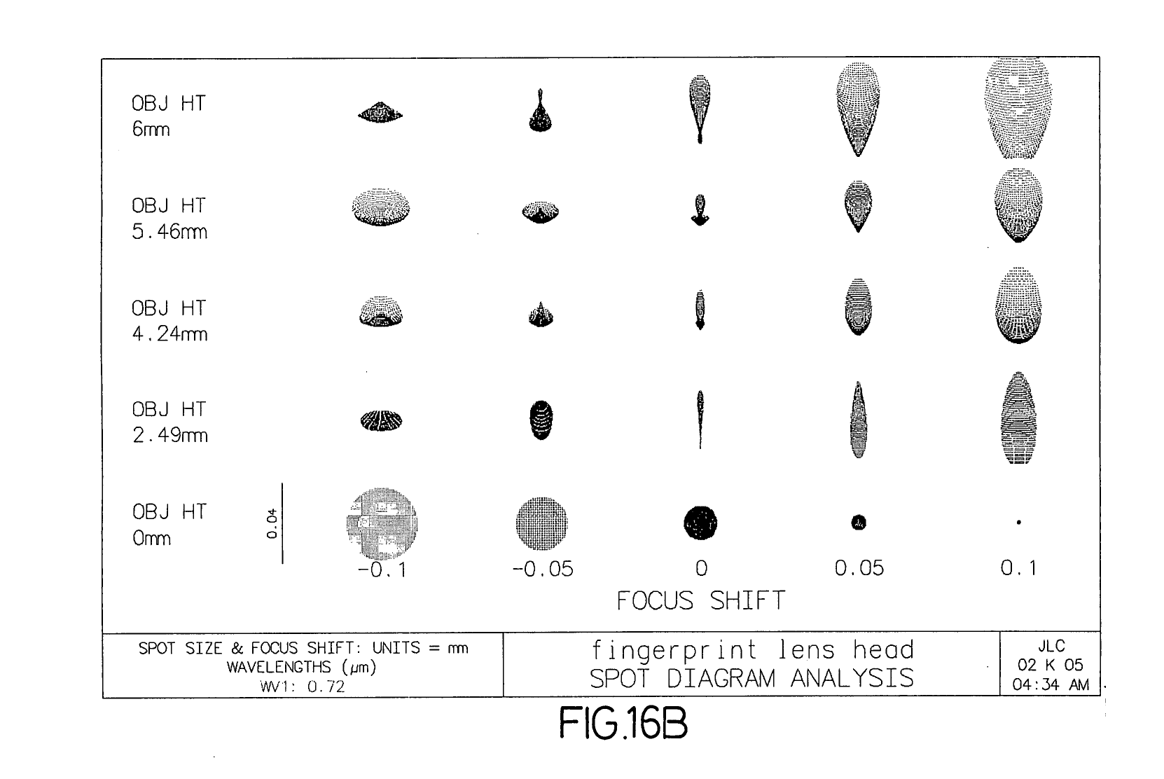

FIG. 5 shows the lens head of a preferred embodiment. FIG. 6 shows the typical aberration behavior of the lens head in FIG. 1. FIGS. 7A and 7B show the typical MTF performance of the lens head in FIG. 1. FIGS. 8A and 8B show the distortion plot and spot diagram of the lens head in FIG. 1. FIG. 9 shows the lens head of a preferred embodiment. FIG. 10 shows the typical aberration behavior of the lens head in FIG. 9. FIGS. 11A and 11B shows the typical MTF performance of the lens head in FIG. 9. FIGS. 12A and 12B show the distortion plot and spot diagram of the lens head in FIG. 9. FIG. 13 shows the lens head of a preferred embodiment. FIG. 14 shows the typical aberration behavior of the lens head in FIG. 13. FIGS. 15A and 15B show the typical MTF performance of the lens head in FIG. 13. FIGS. 16A and 16B show the distortion plot and spot diagram of the lens head in FIG. 13.

With reference to FIG. 1, it is noted from the depiction that the fingerprint identification assembly in accordance with the present invention includes a laminated lens (2), at least one illuminator (3) and a sensor (4).

The present invention is using the light from the at least one illuminator (3) to show the image of the fingerprint on top of the laminated lens (2). Due to the structure of the laminated lens (2), light from the at least one illuminator (3) is partially reflected and partially penetrates through the laminated lens (2) so that the image of the fingerprint on top of the laminated lens (2) is able to be clearly presented for the sensor (4).

With reference to FIG. 2, the first preferred embodiment of the present invention is shown, wherein the laminated lens (2) is composed of a first lens (21), a second lens (23) and a third lens (24) formed together with the first lens (21) and the second lens (23). Preferably, there are two illuminators (3) provided on the bottom of the laminated lens (2) and the sensor (4) is located under the laminated lens (2). Preferably, the first lens (21), the second lens (23) and the third lens (24) are made of glass, plastic or a combination of glass and plastic. Further, a metal film or a dielectric film (A) is applied to each of the first lens (21), the second lens (23) and the third lens (24) so that light from the least one illuminator (3) is partially reflected and partially penetrates through the second lens (23) and the third lens (24).

When the assembly of the present application is employed, light from the at least one illuminator (3) is projected to the first lens (21). Then due to the undulated pattern of the fingerprint on top of the first lens (21), a first reflected light beam (b1) and a first penetrating light beam (b2) passing through the second lens (23) are generated. The first penetrating light beam (b2) reflected by the third lens (24) so as to generate a second reflected light beam (b3) to the second lens (23). The second reflected light beam (b3) is then turned into a third reflected light beam (b4) after being reflected by the second lens (23). The third reflected light beam (b4) is projected to and penetrates the third lens (23) to generate a final light beam (b5) to be picked up by the sensor (4). Therefore, it is concluded that the light path from the at least one illuminator (3) is:

b1→b2→b3→b4Δb5→image. Preferably, the laminated lens (2) of the present invention has a thickness limitation of 15 mm such that the light path from the at least one illuminator (3) is prolonged and thus the incidence light angle to the sensor (4) is small. Therefore, the overall volume of the fingerprint identification assembly of the present invention is compact.

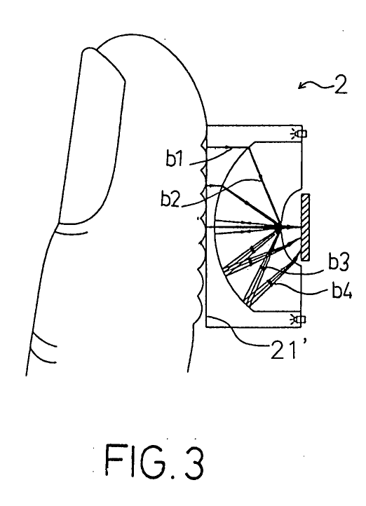

With reference to FIG. 3, the embodiment as shown has a structure substantially the same as that shown in FIG. 2. The only difference therebetween is that the first lens (21′) has a flat top surface.

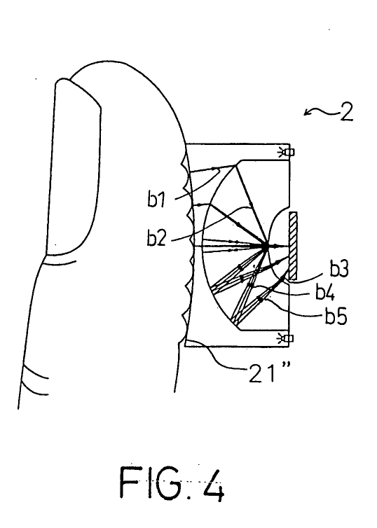

With reference to FIG. 4, the embodiment as shown has a structure substantially the same as that shown in FIG. 2. The only difference therebetween is that the first lens (21″) has a concave top surface.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fingerprint identification assembly comprising:
a laminated lens having a first lens, a second lens and a third lens formed together with the first lens and the second lens, each of the first lens, the second lens and the third lens has a film coated thereon;
at least one illuminator located at a bottom of the laminated lens; and
a sensor located under the laminated lens for picking up an image of a fingerprint on top of the laminated lens, wherein the film of the laminated lens allows light from the at least one illuminator to be partially reflected due to the fingerprint on the laminated lens and partially penetrates through the second lens and the third lens to be picked up by the sensor.

2. The assembly as claimed in claim 1, wherein the first lens has a flat top surface.

3. The assembly as claimed in claim 1, wherein the first lens has a concave top surface.

4. A fingerprint identification assembly comprising:
a laminated lens having a first lens, a second lens and a third lens formed together with the first lens and the second lens, each of the first lens, the second lens and the third lens has a dielectric film coated thereon;
at least one illuminator located at a bottom of the laminated lens; and
a sensor located under the laminated lens for picking up an image of a fingerprint on top of the laminated lens, wherein the dielectric film of the laminated lens allows light from the at least one illuminator to be partially reflected due to the fingerprint on the laminated lens and partially penetrates through the second lens and the third lens to be picked up by the sensor.

5. The assembly as claimed in claim 4, wherein the first lens has a flat top surface.

6. The assembly as claimed in claim 4, wherein the first lens has a concave top surface.

7. The assembly as claimed in claim 1, wherein the lenses are made of a material consisting of glass, plastic or the mixture thereof.
